(19) United States
(12) Patent Application Publication
(10) Pub. No.: US 2007/0129960 A1
(43) Pub. Date: Jun. 7, 2007

(54) CORPORATE ACTIONS MONITORING, EVALUATION AND NOTIFICATION SYSTEM AND METHOD

(76) Inventor: Brendan P. Farrell JR., Denville, NJ (US)

Correspondence Address: W. EDWARD RAMAGE, COMMERCE CENTER SUITE 1000, 211 COMMERCE ST, NASHVILLE, TN, 37201, US

(21) Appl. No.: 11/608,113

(22) Filed: Dec. 7, 2006

Related U.S. Application Data
(60) Provisional application No. 60/748,116, filed on Dec. 7, 2005.

(51) Int. Cl. G06Q 99/00

(52) U.S. Cl. 705/1

(57) ABSTRACT

A computer-based, secure system for receiving, processing, analyzing, evaluating and reporting corporate action information. The system provides a functional data environment for processing corporate action information, keeping track of securities, holders, accounts, officers, and other types of essential corporate actions records, and generating appropriate notifications and responses. Corporate action data may be improved from various data sources.

This application claims the benefit of and priority to U.S. Provisional Application No.60/748,116, filed Dec. 7, 2005, and is entitled to the benefit of that filing date. The specification, drawings, attachments and complete disclosure of Provisional Application No.60/748,116 are incorporated herein by reference.

### FIELD OF INVENTION

This invention relates to a system and method for the automated processing, evaluation, and reporting of corporate action information.

### BACKGROUND OF INVENTION

The monitoring and evaluation of various corporate actions, including any announcements made by a corporation, is important to a variety of entities, including but not limited to brokers, dealers, investment management firms, trust banks, custodial banks, and other financial institutions.

These entities historically have relied on traditional news sources for such information, which can be time-consuming, inefficient, and lead to the delayed receipt, or even non-receipt, of important information. Corporate action data vendors have begun accumulating and providing this information, often in bulk form, but the volume of information itself often could be overwhelming. Moreover, with information processed manually through a number of financial intermediaries within tight deadlines, data often may be conflicting, incomplete, or incorrect. As a result, mistakes may be frequently made, leading to significant financial losses.

Accordingly, what is needed is an faster, more efficient means of receiving, reviewing, analyzing, evaluating, and reporting corporate action information, and making decisions and determining appropriate responses based on such information.

### SUMMARY OF THE INVENTION

The present invention relates to a computer-based secure system for receiving, processing, analyzing, evaluating, and reporting corporate action information. In one exemplary embodiment, the system provides a functional data environment for processing corporate action information, keeping track of securities, holders, accounts, officers, and other types of essential corporate actions records, and generating appropriate notifications and responses. Corporate action information may be imported from various data sources, including but not limited to corporate action data vendors and client trust or settlement systems. Corporate action information can be imported on any time schedule, including hourly or daily, or whenever a particular announcement or event takes place. Information may be imported for individual actions, groups of actions, or in bulk. In one embodiment, the corporate action information is imported so as to provide the most up-to-date information possible.

In another exemplary embodiment, the system includes a scheduler module that acts to manage the importing and initial processing of the data feeds. One function of the scheduler module is the scheduling of the importing routines. Importing routines may be scheduled to run at pre-set intervals (known as intra-day processes) or automatically run once or twice at a pre-set time every day. Importing routines may be run 24 hours a day, 7 days a week.

Another function of the scheduler module is the handling and processing of the imported data into a database. This includes a variety of database-related procedures. In one exemplary embodiment, the database is a relational database, which may be located on a dedicated ODBC (Open Database Connectivity) database server or other network database server.

In another exemplary embodiment, users can gain access to the corporate action information through a toolbar module. In one exemplary embodiment, the toolbar module allows any kind of data record to be manually reviewed and/or modified by the user. It also provides other forms of review functionality, as well as other functions like report generation or manual notification distribution.

In a further exemplary embodiment, a remote response module enables certain end-users to view and submit responses to corporate actions from remote locations. The remote response module communicates with the system through various means, including but not limited to the Internet or web. The remote response module works in conjunction with the toolbar module and the scheduler module.

In yet another exemplary embodiment, an archive viewing module enables the user to save and view data records in the database.

The corporate actions system may be installed in a network, in a client/server environment, or as a stand-alone system. For example, the scheduling module and the toolbar module can be run successfully on the same machine as well as independently. Alternatively, a single dedicated server can run the scheduling modules, while a number of separate workstations or network client computers run a plurality of toolbar modules.

### DESCRIPTION OF THE DRAWINGS

FIG. 1 is a diagram of one embodiment of the subject invention.

FIG. 2 is a diagram of data flows in accordance with one embodiment of the subject invention.

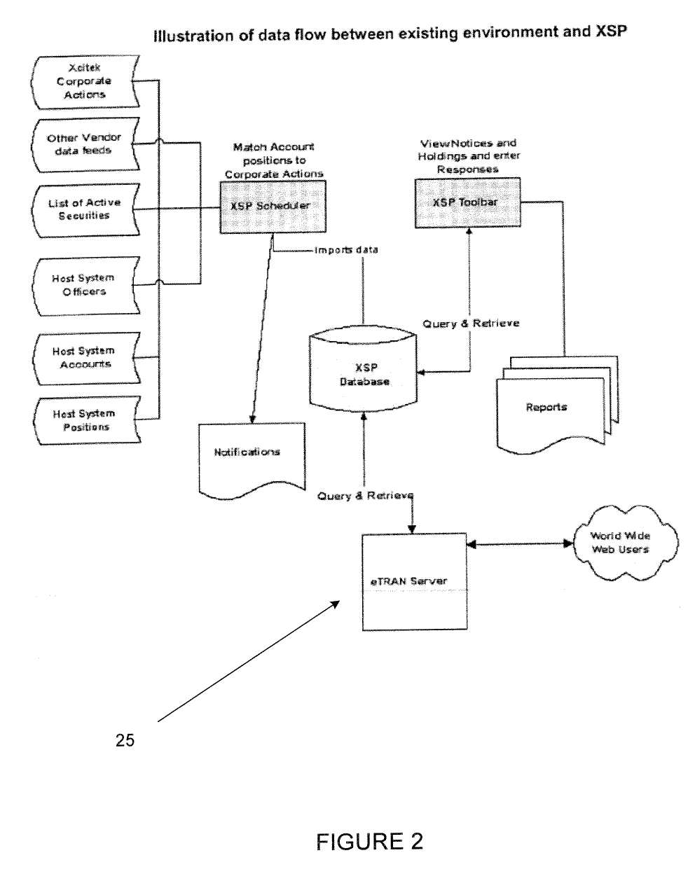

FIG. 3 is a diagram of a system architecture in accordance with one embodiment of the subject invention.

FIG. 4 is a diagram of a system architecture in accordance with another embodiment of the subject invention.

FIG. 5 is a diagram of a system architecture in accordance with another embodiment of the subject invention.

### DESCRIPTION OF INCORPORATED EXHIBITS

The following exhibits, which were attached to and filed with and as part of U.S. Provisional Application No.60/748,116, filed Dec. 7, 2005, are incorporated herein in their entirety by reference:

Exhibit A—“XSP Marketing Literature—US Version Updated as of 09/26/05” (12 pages).

Exhibit B—“XSP Release Notes—Version 4.61.0001” (8 pages).

Exhibit C—“Release Notes—XSP 4.50” (18 pages).

Exhibit D—“XSP Version 4.61 Scheduler Guide” (22 pages).

Exhibit E—“XSP Version 4.61 Toolbar User's Guide” (104 pages).

Exhibit F—“XSP Version 4.61 eTRAN User Guide” (9 pages).

Exhibit G—“XSP Version 4.61 Administration Guide” (46 pages).

Exhibit H—“eTRAN Installation Guide: XSP 4.5” (24 pages).

### Detailed Description of Exemplary Embodiments

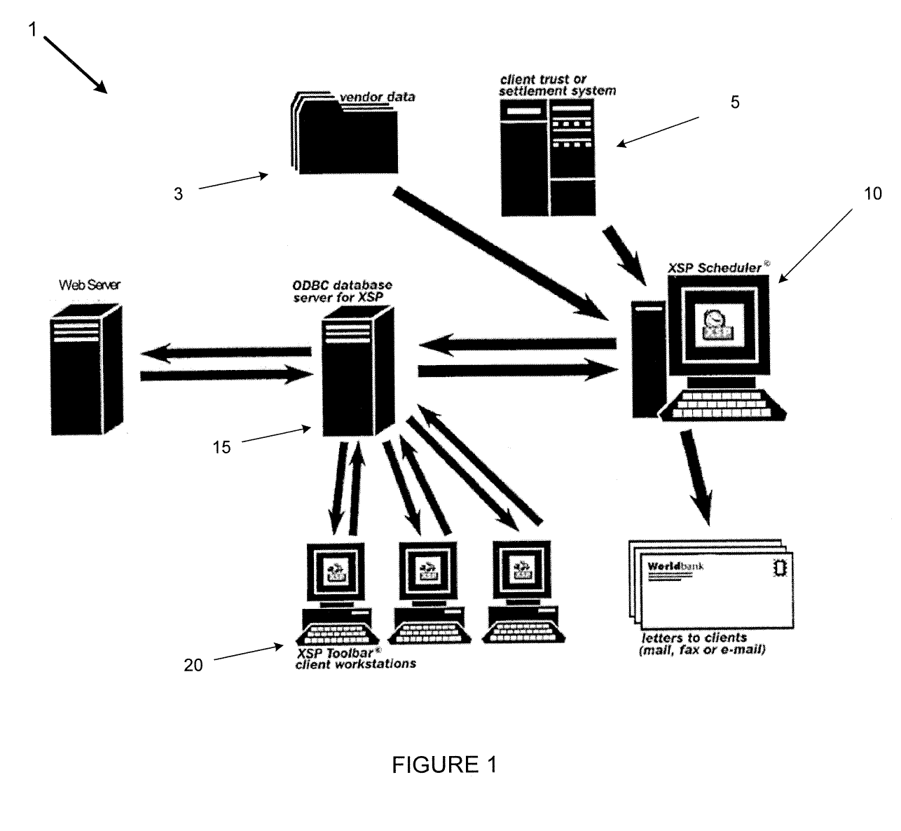

The present invention relates to a computer-based secure system for receiving, processing, analyzing, evaluating, and reporting corporate action information. Referring now to the numerous figures, wherein like references identify like elements of the invention, FIG. 1 illustrates an overview of a corporate actions system 1 according to one embodiment of the present invention.

The corporate actions system 1 provides a functional data environment for processing corporate action information, keeping track of securities, holders, accounts, officers, and other types of essential corporate actions records, and generating appropriate notifications and responses. Corporate action information is imported from various data sources, including but not limited to corporate action data vendors 3 and client trust or settlement systems 5. Corporate action information can be imported on any time schedule, including hourly or daily, or whenever a particular announcement or event takes place. Information may be imported for individual actions, groups of actions, or in bulk. In one embodiment, the corporate action information is imported so as to provide the most up-to-date information possible.

In one exemplary embodiment, a scheduler module 10 acts to manage the importing and initial processing of the data feeds. One function of the scheduler module 10 is the scheduling of the importing routines. Importing routines may be scheduled to run at pre-set intervals (known as intra-day processes) or automatically run once or twice at a pre-set time every day. Importing routines may be run 24 hours a day, 7 days a week.

Another function of the scheduler module 10 is the handling and processing of the imported data into a database 15. This includes a variety of database-related procedures. In one exemplary embodiment, the database is a relational database, which may be located on a dedicated ODBC (Open Database Connectivity) database server or other network database server. Examples of specific database types include, but are not limited to, Microsoft SQL, Sybase, or Oracle.

Users gain access to the corporate action information through a toolbar module 20. In one exemplary embodiment, the toolbar module 20 allows any kind of data record to be manually reviewed and/or modified by the user. It also provides other forms of review functionality, as well as other functions like report generation or manual notification distribution.

In another exemplary embodiment, a remote response module 25 (referred to by the name “eTRAN”) enables certain end-users to view and submit responses to corporate actions from remote locations. The remote response module 25 communicates with the system through various means, including but not limited to the Internet. The remote response module works 25 in conjunction with the toolbar module 20 and the scheduler module 10.

In yet another exemplary embodiment, an archive viewing module 30 enables the user to save and view data records in the database 15. Typically, this occurs after a purging process is performed on the database 15.

The corporate actions system 1 may be installed in a network, in a client/server environment, or as a stand-alone system. For example, the scheduling module and the toolbar module can be run successfully on the same machine as well as independently. Alternatively, a single dedicated server can run the scheduling modules, while a number of separate workstations or network client computers run a plurality of toolbar modules.

In one exemplary embodiment, the order of processing of data from data vendors and other data sources is as follows:

1. retrieving of data from data vendors (download or FTP supported);

2. importing data into database;

3. producing “active XSP” export file, which is a file of records containing a list of active securities;

4. extracting by the host system of account positions held in the active securities;

5. extracting by the host system of accounts and account officers (e.g., broker, account executives, etc.);

6. transferring host system extracted information to the server hosting the scheduling module;

7. importing and/or updating officers and accounts data;

8. importing position data and matching said data to vendor corporate actions;

9. queuing outgoing notifications; and

10. generating automated reports.

In another exemplary embodiment, imported data may be used to create “common corporate actions” or corporate action announcements. The behavior and life-cycle of common corporate actions is determined by a rules-based system that flexibly adapts to a variety of corporate action processing environments. Rules are set at the corporation action type level. Corporate action types categorize types of corporate actions within the system and contain all of the processing parameters applicable to events of a specific type.

The system may be multi-level, and associates incoming data with the particular end users who will be viewing and processing that data, as well as the recipients who will be sent the notifications. The internal hierarchy of business entities, accounts, assignees, and officers may be as simple or as complex as required for a particular installation. View and list screens are used by the user or user groups to effectively analyze corporate action data after it has been received and organized. These screens may provide query and sort features adapted to filter selected subsets of the data. In addition, many different kinds of individual view screens may be used to expand upon and provide details regarding a specific corporate action. The various screens may be pre-established, or may be modified or supplemented for customized applications.

Through work queues, common corporate actions may be automatically routed for processing by different individuals within an organization based on user-defined criteria. When more diversification is necessary, work views may be used. This flexibility allows a large user group to easily manage or “scrub” corporate action data traffic. Corporate action data thus may be distributed based on multiple criteria, including but not limited to corporate action type, geographic area, country, issuer, mandatory/voluntary status, and workflow status.

In yet another exemplary embodiment, workflow processing is used to determined the completeness of a corporate action in preparation of distribution. Workflow processing may be field-based. The system alerts the user about corporate actions requiring supplemental information, which keeps the process flow functioning smoothly.

In another exemplary embodiment, the corporate action view screen displays common corporate action data, and can also be used to manually enter corporate actions into the system. A custodian corporate actions module may be used for more streamlined rapid data entry.

In order to permit multiple identifiers to be maintained for a single security, all data about a security is held in a “vertical” table or security matrix. This permits the importation of security data from outside systems or vendors. All major international numbering systems are represented.

The system 1 matches corporate action information and announcements with all accounts and individual holders who possess units or shares of securities to which the corporate action information and announcements relate. This position match process supplements the security information and identifies exactly which clients hold securities and how much of them they hold. The system then can generate and queue notifications. In one exemplary embodiment, the system generates customizable notifications that may be sent to various recipients to inform them about actions on their securities.

Notifications can be generated using existing templates or customized using a notification editor, which allows full control over the look of a notification, and which fill-in and mail-merge-style fields will automatically populate with information about the recipient and the number of shares held.

The system then generates and, in some embodiments, distributes notifications (in the case of email and fax) to the intended recipients. This may be totally or partially automated, or manually controlled, according to an organization's procedural needs.

The system 1 also may assist in managing and tracking responses where the corporate action is a voluntary corporate action where a response is expected. Users are permitted to enter specific responses to announcements, and the responses are stored in the system's data tables and maintained with the rest of the data. This process handles not only ordinary voluntary corporate actions such as tender offers, but also special actions, such as partial call lotteries (in the United States) and elections to Dutch Auction offers.

In yet another embodiment, the system 1 allows extensive report creation. Reports include a library of pre-programmed data reports which provide a convenient and organized means of reviewing corporate action records. Reports provide query and sort features used to filed selected subsets of the whole body of data, based on a variety of report criteria. Users also can create customized reports that can be saved and recalled, including “child” reports based on “parent” report settings.

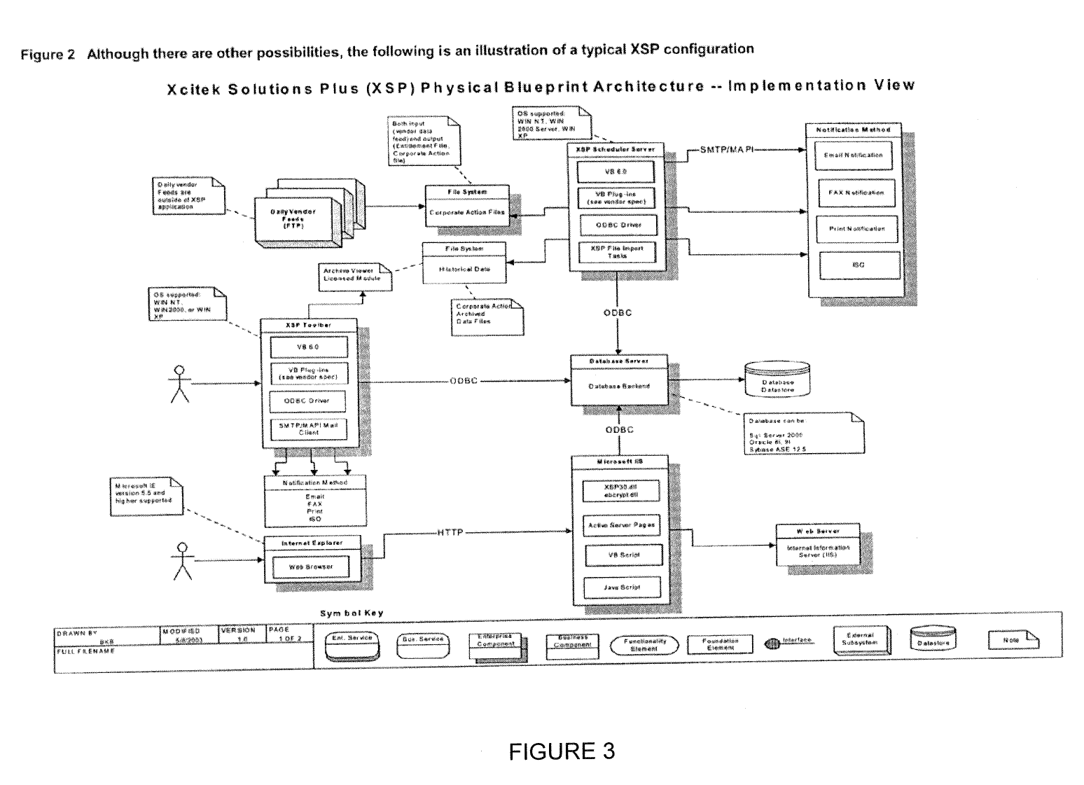

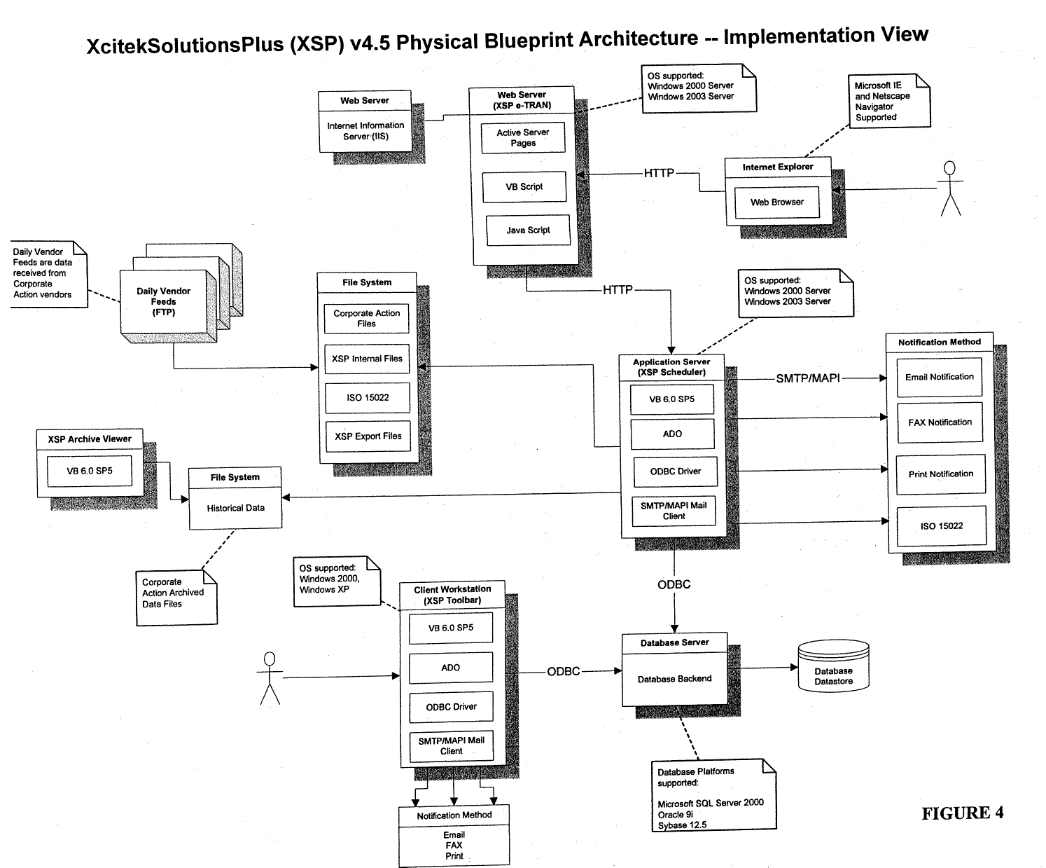

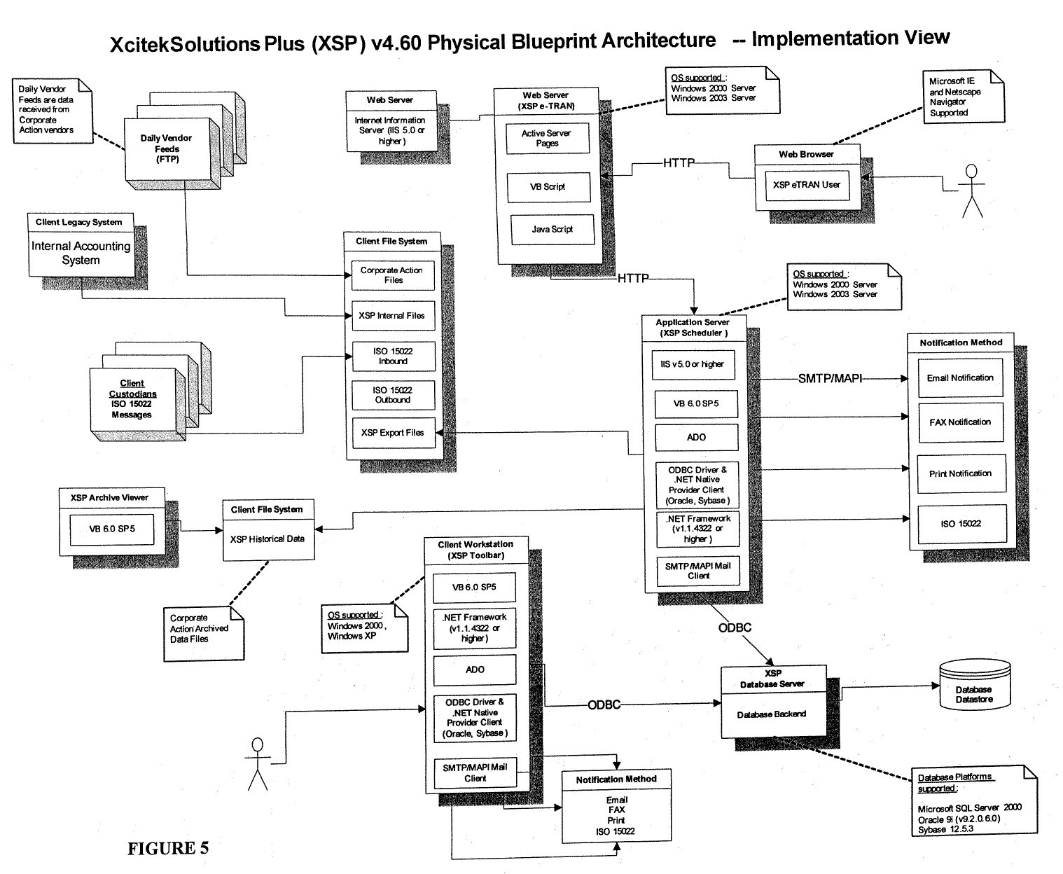

The system 1 can be adapted to handle any client needs with regard to a variety of parameters. Thus, as a nonlimiting example, an installation of the system for a “large” client can handle over 250,000 accounts, over 5000 officers, over 500,000 securities, over 2.5 million holdings, over 5 vendors, over 30 toolbar users, and/or over 5000 eTRAN users. Hardware and software requirements will vary depending on the size of the installation. FIGS. 3, 4 and 5 show various exemplary embodiments of several system architectures, with the major components identified.

In one exemplary embodiment, the present invention may be used as an enterprise-wide, global corporate actions system, such as the “XSP” system from Xcitek. XSP minimizes the operational risks and costs associated with the processing of corporate actions by eliminating manual intervention, reducing reliance on paper notifications, and removing the need to re-key data. In this embodiment, the invention enables financial institutions to achieve end-to-end “Straight-Through Processing” (“STP”) for this complex operation.

XSP's rules-based workflow engine analyzes and verifies all items relevant to the corporate actions lifecycle while eliminating the risk of missing an announcement. XSP's workflow can route all exceptions based upon assigned work queues created by a user streamline the process flow and increase control while reducing risk. XSP is scalable, and enables financial institutions to process increased volumes without incurring additional overhead, bringing an immediate return on investment. In this embodiment, XSP provides a flexible, proven and cost-effective alternative, which is typically implemented and in production within a few months.

XSP integrates easily with a user's existing infrastructure, and delivers the following functionalities for corporate actions automation: data management, notification and response handling, and entitlements.

With regard to data management, XSP captures, scrubs and validates corporate actions data from multiple vendor and custodian sources (including 30 or more distinct market data vendor interfaces in their own proprietary formats or a standard format, such as the SWIFT ISO 15022 compliant format)—to create the “golden copy” or “composite record.” The data management component of XSP is the first step in the corporate actions STP chain, and interfaces with the other components of the XSP system.

One element of the data management component is the creation of a single composite notice or “golden copy” for each corporate action. In one exemplary embodiment, the “golden copy” is produced in three parts: (i) original vendor raw announcement; (ii) normalized data view; and (iii) composite announcement. Having automatically prioritized each event according to group and user parameters, XSP allows users to manually enrich the announcement data within the composite notice. A comprehensive audit file details all amendments or changes made to any data element, and logs who made the change and when.

The final data is then stored in XSP's highly scalable, secure and robust database. Users have the flexibility to view and query all data according to any notice type business rule until the purge criteria date has been reached. After this point, XSP's archive viewer component provides access to archived data through a separate window.

In one embodiment, XSP offers a comprehensive corporate actions data interface to meet each user's individual needs. With access to more than thirty distinct electronic sources, XSP captures, reads, maps and normalizes data in real-time, from the world's leading suppliers of corporate actions information, including but not limited to Xcitek, Bloomberg, The Canadian Depository for Securities Ltd. (“CDS”), The Depository Trust & Clearing Corporation (“DTCC”), Exchange Data International (“EDI”), Fidelity ActionsXchange, FT Interactive Data, Nikkei, Standard & Poor's (“S&P”), Telekurs, and others. Data sources can be received into XSP in their own proprietary formats with all different industry standard security identifiers (including ISIN, SEDOL and CINS/CUSIP) and unique event labels. XSP normalizes these disparities and provides the user with a single, standardized and cleansed composite announcement for automated downstream processing. In addition, XSP can interface to any custodian or vendor data source delivered in the SWIFT ISO 15022 format.

XSP also can support an internal security matrix file interface. This is in addition to proprietary security components, such as the Telekurs/S&P ISIDPlus security cross reference file. XSP builds security detail records within a Vertical Matrix Cross-Reference (“VMCR”) table to allow for multi-market processing. All ISO standard security identifiers as well as client's internal identifiers can be supported. Exception work queues can be configured to track security ID conflicts and duplicate records.

XSP can provide flexibility to facilitate user-defined access for manual exception processing. XSP's flexible rule-set enables financial institutions to pre-define the workflow and assigned work queues routing for mandatory, optional and voluntary notices. Buy- and sell-side financial institution professionals are able to concentrate on ‘incomplete’ or ‘in conflict’ data only, reducing operational risks and improving efficiencies.

For each of the numerous corporate action types (which can be more than 90 or 100 in some embodiments), XSP enables users to configure multiple data sources, data field priority (e.g., critical, required, optional), and multiple matching logic criteria, as well as other business rule requirements. XSP allows the user to configure Country of Issue (“COI”) templates to further define market-specific processing rules. Work queues are configurable at the COI level for exception and workload distribution.

XSP's flexible rule-set also allows for corporate action event type configuration within multiple business entities of a financial institution. For example, business rules can be configured to support different stock record position matching logic at either the ex-date or record date based upon the unique business entity requirement.

XSP data management tools may include a scheduler module (which establishes a portal to the XSP database for importing, managing, and processing of all data feeds); a tool bar module (which enables data records to be manually reviewed and modified, and enables report generation and/or manual notification distribution); electronic work queues, views and alerts (which allow for user-defined workflow management and exception processing); an ad-hoc management report module (which allows the user to create an unlimited amount of reports based on their requirements); an archive viewer (which enables the user to save and view records after the purging process), and a Vertical Matrix Cross Reference (VMCR) table (which cross-references security identifiers to allow for multi-market processing and ensure events are properly matched to create a composite record).

With regard to notification and response, the notification and response component of XSP eliminates the manual notification and response capture effort, significantly reducing potential for human error. The automatic tracking of aggressive response deadlines and of responses with XSP allows financial institutions to minimize risk while making timely, informed investment decisions.

XSP enables financial institutions to automate the creation and delivery of corporate action notifications within a decision maker's designated account, book or portfolio irrespective of their physical location. The flexible notification templates cater to an extensive list of client types, from high net worth individuals to institutional clients and traders that may require more detailed information. Corporate action notifications are automatically created based upon any combination of event type, recipient profile (which can be multiple per account) or action status.

XSP matches events against holdings and transactions on a daily or intra-day basis, generating automated event notifications to, and responses from, decision makers across disparate locations and geographies, according to each user's parameters, preferences and desired notification methods. In another embodiment, a client-hosted extension of the notification and response component is provided in the form of eTRAN (Electronic Tracking Response and Notification), a comprehensive web-reporting tool which allows decision makers to receive and review corporate actions announcements and submit responses and voting instructions from anywhere with intranet/internet access. In addition, XSP's ISO messaging module captures MT565 instructions and automatically feeds to custodians and downstream processing systems, eliminating the risks associated with this manual process.

XSP facilitates numerous notification delivery modes including ISO 15022, eTRAN (web browser), email, fax and print. eTRAN is a user-friendly, web-based electronic tracking response and notification tool, and enables decision makers to view details of their account and submit instructions on voluntary Corporate Actions in real-time, 24 hours per day/7 day per week, for end-to-end STP. In addition, XSP delivers, receives and automatically processes SWIFT ISO 15022 messages. XSP fully supports the MT564 & MT568, MT565, MT567, and the MT566, among others.

XSP allows the user to configure specific default standing instruction rules at the Corporate Action event and Country of Issue (“COI”) levels. Special notification of merge fields have been created to allow the user to send notifications to account recipient or investment officer advising them of events where their standing instructions will be used unless otherwise notified. Configurable instruction processing dates have been added at the event type level allowing the user to specify the standing instruction, calculate the entitlement, and then export to the user's internal legacy system.

XSP enables financial institutions to automatically track voluntary corporate action responses at the agent or custodian detail holding level by the deadline date and time. This ensures that all instructions are received, validated, reconciled and processed. XSP can track multiple response statuses at the holding detail level including Incomplete, Exception and Complete response statuses. XSP also allows for the system to be configured requiring approval for responses entered via the desktop (Toolbar) and eTRAN (web-browser). This allows the client to establish supervisory control for maker-checker functionality.

As responses are received into the XSP database, an election reconciliation process can be generated to report any out of balances as well as elections received but not processed with the agent or custodian. Work queues can be configured for response tracking and workflow. The system also provides for multiple levels of security (in one embodiment, up to ten levels).

In one embodiment, eTRAN (Electronic Tracking Response and Notification) is the web-based, electronic notification and response capture and tracking tool in XSP. This comprehensive, user-friendly and time-efficient module enables decision makers to view details of corporate actions impacting their accounts and submit instructions on voluntary and optional corporate actions in real-time, 24 hours per day/7 days per week, for end-to-end STP. eTRAN users can view, query, track and elect on all pending voluntary or optional corporate actions via the Internet or web, and submit direct election instructions. In addition, all mandatory and partial call lottery results can be displayed. Calculated entitlements are also displayed in the eTRAN web browser for users to determine receipt of payment and cash flow investment needs. eTRAN further provides query tools that can be customized allowing users the ability to proactively respond 24 hours a day/7 days a week to corporate action announcements.

The eTRAN user is only associated to specific accounts in which they have fiduciary responsibility. For example, when the user selects “Show All Corporate Actions Requiring Responses,” only those accounts for which they are responsible are displayed.

XSP automatically generates email notifications, containing a web link, to designated eTRAN users, to notify them of pending corporate actions impacting their accounts. Within the notification on eTRAN, XSP encompasses potential entitlement calculations. Potential entitlements are automatically calculated on all voluntary and optional corporate actions based on the payout types within each option. When the user opens the corporate action they will be able to see the calculated potential entitlement for each of the various options.

Potential entitlements allow the user to make a better investment decision on which option (or options) to select. Once the user makes their election, the system calculates the actual entitlement based upon the units elected within each option. The actual entitlement is then eligible for export via the Entitlement Export File based on client configured business rules for downstream processing. If required, the user can configure the system to require approval on the elections via eTRAN before updating the XSP database. eTRAN responses are fully audited with time and date stamps. eTRAN also provides the user with a response detail and summary report that can be printed off the web browser for their records.

In one embodiment, XSP's ISO messaging component enables users of the system to accept and generate SWIFT ISO 15022 formatted messages for accurate communication of corporate action notices, instructions, confirmations and entitlements. XSP enables financial institutions to accept, generate and interpret corporate actions data from any vendor or custodian that can deliver messages in the ISO 15022 format for all corporate actions communications:

MT564—Notification of Event

MT565—Response Instruction

MT566—Corporate Action Confirmation

MT567—Confirmation of Response

MT568—Narrative

XSP supports the ISO inbound MT564/568 message import. All ISO-required data fields are mapped in accordance to the XSP data management module. Multiple custodian sources can be used to create a “golden copy” or “composite record.” XSP also maps the terms, extended text and restriction information from the MT564 and MT568.

Once the composite record is created, XSP completes a holding reconciliation process whereby XSP matches the safekeeping/depot holdings to the holdings within the account. XSP uses work queue functionality to manage holding reconciliation exceptions.

After the holding reconciliation process is completed, XSP will then create the outbound notification to be sent to the account recipient or investment manager. All outbound ISO notification messages are tracked within the notification queue and can be sent intra-day as well as nightly batch. All outbound notification files can be saved for archive/audit purposes.

XSP maps the entitlement data from the custodian account entitlement block of the MT564 REPE entitlement message. XSP then reconciles the custodian entitlement data against the XSP calculated entitlement. An entitlement reconciliation status is then calculated to determine if there are any discrepancies. All exceptions are automatically distributed via work queues. After the entitlement reconciliation process is completed, XSP creates the outbound notification of entitlement to be sent to the account recipient or investment manager. All outbound ISO notification of entitlements messages are tracked within the notification queue and can be sent intra-day as well as nightly batch. All outbound notification files can be saved for archive/audit purposes.XSP interfaces the inbound MT565 response instruction to the corresponding corporate action within the XSP database. XSP can be configured to ‘auto-match’ the MT565 provided there is a prerequisite MT564 to link to, or XSP can be configured to ‘auto-match’ to an existing corporate action without an MT564. Response statuses are created for exceptions within limits or exceeding limits based upon the eligible units. All exceptions are automatically distributed via work queues.

XSP automatically creates an outbound MT565 response instruction as election responses are processed within the XSP database. The MT565 message includes the custodian or agent bank BIC Code that corresponds to the detail holding location where the security is held. The MT565 message also includes all ISO 15022 data elements required to process the instruction. All outbound messages are tracked within the election instruction queue and can be sent intra-day and/or nightly batched.

XSP interfaces the Inbound and Outbound MT567 Confirmation of Response based upon Corporate Action elections within the XSP database. The system will automatically create the MT567 Outbound to the account recipient or investment manager based upon elections being processed. XSP also processes the Inbound MT567 Confirmation of Response from the local agent or custodian bank. During the confirmation and validation process within XSP, the MT565 will be updated to validate the MT567 has been received. Work queues can be configured to track all MT565 that have not received a corresponding MT567. All files can be saved for archive/audit purposes.

XSP maps the MT566—Corporate Action Confirmation entitlement payment data—from the custodian entitlement payment block. XSP then reconciles the custodian payment data against the XSP calculated entitlement. An entitlement payment reconciliation status is then calculated to determine if there are any payment exceptions. All payment exceptions are automatically distributed via work queues. The system can be further configured to re-export entitlement data upon receipt of a MT566 with confirmed and reconciled status. XSP will automatically create an Outbound MT566 to the account recipient or investment manager upon confirmation and reconciliation of payment.

With regard to entitlements, XSP has links to user's books and records in order to get entitlement information as well as trade activity information. XSP calculates entitlements and can be tightly integrated seamlessly with the user's internal accounting engine to process the movement of cash or securities. The calculation of entitlements is critical to the corporate actions process for identification to account recipient or investment manager, response capture/processing, receipt and reconciliation of payment. In one exemplary embodiment, the entitlement module within XSP completes the Straight-Through Processing (“STP”) of the corporate action lifecycle. The entitlement (API) export easily interfaces with clients' existing back-office or accounting systems.

Corporate action entitlements are automatically calculated during the holdings match process. For mandatory corporate actions, entitlements are based on the eligible units as determined by the client's business rules. For voluntary or optional corporate actions, XSP will automatically calculate on option and payment details. Actual entitlements will be calculated when the user has made their election on the desired option.

Actual and potential entitlement data elements can be included on the notification that is sent to the account recipient or investment officer. The entitlement data is also displayed on eTRAN, enabling decision makers to view details of corporate actions impacting their accounts and submit instructions on voluntary and optional corporate actions in real-time, 24 hours per day/7 days per week, for end-to-end STP.

XSP allows the user to configure specific default standing instruction rules at the corporate action event and Country of Issue (COI) levels. Special notification of merge fields have been created to allow the user to send notifications to account recipient or investment officer advising them of events where their standing instructions will be used unless otherwise notified. Configurable instruction processing dates have been added at the event type level allowing the user to specify the standing instruction, calculate the entitlement, and then export to the user's internal legacy system.

In one embodiment, XSP has a withholding tax import file containing account domicile, and COI withholding tax detail for the following fields: Withholding Tax Amount: COI withholding tax; Expense Amount: COI tax expense amount; and Reclaim Amount: COI reclaim amount.

For dividend and interest payments, XSP calculates the gross entitlement amount, the withholding tax amount, the expense amount, the reclaim amount, and the net entitlement amount.

Transaction processing for trade activity is handled as follows:

Unsettled Trades/Exception Acceptances: XSP imports a file containing the client's outstanding transactions such as unsettled trades, identifying pending, failing, borrow, and loan trades. In addition, XSP calculates entitlements on these transactions. XSP allows users to vote on pending and failing transaction exceptions. Once the exception election is made, it is included in the downstream entitlement calculation. XSP provides a complete stock record report that allows the user to reconcile the stock record on XSP with the custodian or depot. The complete stock record report tracks the events at the security ID, corporate action type, unique corporate action ID, business entity, and custodian location. The report will net out the settled balance with the transactions and then subtract the traded balance. All exceptions and balances are displayed within the report.

Ex/Cum Dividend Trades: XSP supports an ex-cum indicator within the transaction file. This can be imported into the system or manually edited by the corporate actions analyst. Stock record expectations due to ex-cum trades can be reconciled and adjusted by the user on XSP for balancing purposes.

Amendments to Trades: XSP will import positions into its holdings database on an intra-day basis. When any holding or transaction occurs within the system, XSP automatically recalculates the entitlement and re-exports the file. The recalculation is performed at the holding detail level.

XSP can track market and liability claims within the database through its transaction import file. The transaction import file allows the user to import details for pending, failing, borrow and loan transaction details. The transaction file contains trade date, settlement date, counterparty, units and other information required for reconciliation, liability and/or claims purposes. The user can facilitate a claim utilizing the information within the XSP database. XSP also provides a Claim Settled Indicator at the corporate action level to allow the user to track events that have open claims, and then close the events once all claims have been satisfied.

XSP also allows the user to process withholding tax exceptions for Manufactured Overseas Dividends within the holding detail level. Modifications can be made by the user to adjust the defaults withholdings rates on a detailed level. Adjustments can also be made and tracked for securities on Stock Loan. The various negotiated rates can be entered into the system for each detail broker-to-broker or counterparty holding. This information is then exported out of the database into the user's internal legacy systems for further downstream processing.

Once the composite record is created, XSP then completes a holding reconciliation process whereby XSP matches the custodian safekeeping holdings to the holdings within the account. XSP uses work queue functionality to manage holding reconciliation exceptions.

XSP maps the entitlement data from the custodian account entitlement block of the MT564 REPE entitlement message. XSP then reconciles the custodian entitlement data against the XSP calculated entitlement. An entitlement reconciliation status is then calculated to determine if there are any reconciliation exceptions. All exceptions are automatically distributed via work queues.

After the entitlement reconciliation process is completed, XSP will create the outbound notification of entitlement to be sent to the account recipient or investment manager. All outbound ISO notification of entitlements messages are tracked within the notification queue and can be sent intra-day as well as nightly batch. All outbound notification files can be saved for archive/audit purposes.

XSP maps the MT566—Corporate Action Confirmation entitlement payment data—from the custodian entitlement payment block. The XSP application then reconciles the custodian payment data against the XSP calculated entitlement. An entitlement payment reconciliation status is then calculated to determine if there are any payment exceptions. All payment exceptions are automatically distributed via work queues. The system can be further configured to re-export entitlement data upon receipt of an MT566 with confirmed and reconciled status.

XSP will automatically create an Outbound MT566 to the account recipient or investment manager upon confirmation and reconciliation of payment.

Throughout these processes, XSP's event diary workflow engine manages the completion of each step within the corporate actions lifecycle. The diary assigns a task due date and monitors the actual completion date while keeping careful trail of any exceptions incurred in the process.

In one embodiment, XSP uses industry standards such as, but not limited to, ISO 15022. XSP captures announcements from local markets/custodians and facilitates client notifications via MT564 and MT568 messages. XSP also enables users to capture client instructions correctly and automatically feed instructions to custodians via MT565 messages. Additionally, XSP facilitates both inbound and outbound MT566 and MT567 processing for improved STP and substantial risk reduction.

Details of various functions of exemplary embodiments of the system are disclosed in the “XSP Version 4.61 Scheduler Guide”, “XSP Version 4.51 Toolbar User's Guide”, “XSP Version 4.61 eTRAN User Guide”, “XSP Version 4.61 Administration Guide”, and “eTRAN Installation Guide: XSP 4.5”, which are incorporated herein by reference (as noted above, these documents are attached as exhibits to U.S. Provisional Application No.60/748,116, filed Dec. 7, 2005). Nonexclusive descriptions of certain exemplary features are provided below.

In one embodiment, the system comprises an ISO custodian lottery process and enhanced lottery functionality to allow users to automatically lotterize called units reported in MT 564 messages. In particular, the toolbar module comprises a screen permitting users to select corporate actions to be lotterized. This screen will be used if the “security ID type” selection on the lottery view screen is “All,” and multiple security ID types meet the selection criteria when the “Lottery Rapid Entry” button is clicked. Another screen to allow clients to manually edit the corporate actions to be lotterized also may be used. A detailed listing of fields and other elements of this lottery process is provided in the “M14255—ISO Inbound Lottery Process” section of the attached XSP Release Notes—Version 4.61.0001 (pages 2-5), which is incorporated herein in its entirety by reference.

In yet another exemplary embodiment, the entitlement export process is configured by the user to run when a specific date (i.e., an “important date”) is reached, and/or when a corporate action has reached a particular workflow status. This date determines when the entitlement export process is set to be run. A detailed listing of fields and other elements of this process is provided in the “M15649—Modify Entitlement Export to be ‘Date Driven’” section of the attached XSP Release Notes—Version 4.61.0001 (pages 6-7), which is incorporated herein in its entirety by reference.

In yet another exemplary embodiment, corporate action types and fields are selected so as to best represent the data received from each data vendor. A detailed listing of corporate action types and fields is provided in the “XCS062—Enhance CA Types and CA Fields” section of the attached XSP Release Notes—Version 4.61.0001 (pages 8-18), which is incorporated herein in its entirety by reference. Vendor mapping includes these corporate action types and fields to ensure that all such types and fields have consistent, valid mapping. A detailed listing of this mapping is provided in the “XCS063—Enhance Vendor Mapping for All CA Types and CA Fields” section of the attached XSP Release Notes—Version 4.61.0001 (pages 19-20), which is incorporated herein in its entirety by reference.

In yet another exemplary embodiment, the data vendor sources include GCA Validation Service for D and C records. A listing of GCA D record elements and related system components is provided in the “XCS064—Add GCA Import to Vendor File Imports” section of the attached XSP Release Notes—Version 4.61.0001 (pages 21-22), which is incorporated herein in its entirety by reference.

In yet another exemplary embodiment, the data vendor sources also include IDSI Total Dividend, S&P Daily Dividend, and the new Actions Xchange file format for Fidelity. A listing of related system components is provided in the “ACC221 Add Interface for IDSI Total Dividend Service” and “M09633 Add Interface for S&P Daily Dividend Vendor Import” and “M10216 Enhance Application to Support New Fidelity File Layouts” and “M18130 Add Support for October 2005 Fidelity Actions Xchange Format” sections of the attached Release Notes—XSP 4.50 (pages 4, 19-20, 22, 54), which are incorporated herein in their entirety by reference.

In yet another exemplary embodiment, the export processes within the system may use .NET functionality to improved the performance and scalability of the export processes, as well as allowing the export to be retrieved by third party applications. In one configuration, the system keeps track of the date that an entitlement export was run, as opposed to when it will be run or is set to be run. A detailed listing of this enhancement of the export processes is provided in the “XCS065—Enhance CA and Entitlement Exports” and “XCS076—Enhance CA and Entitlement Exports, Phase 2” sections of the attached XSP Release Notes—Version 4.61.0001 (pages 23-29), which are incorporated herein in their entirety by reference.

In yet another exemplary embodiment, the scheduling module comprises an asynchronous option in the daily frame, which users can choose to allow two or more scheduler process to run simultaneously. The scheduler file configuration screen allows user to enter all file locations for processes at one time. A detailed listing of these components is provided in the “ACC270 Enhance Scheduler Processing” section of the attached Release Notes—XSP 4.50 (pages 5-9), which is incorporated herein in its entirety by reference.

In one exemplary embodiment, a user may elect on short (negative) positions in the eTRAN module. As this may create problems for some users due to users voting on shares that they do not possess, in an alternative exemplary embodiment the preferences screen permits clients to control whether or not a user can vote on short positions. If the client has elected to not allow users to vote on short positions (i.e., by leaving the preference unchecked), the user will receive a warning message when a vote on a short position is attempted. A detailed description of this configuration is provided in the “BOA006 Add Short Position Removal Option to eTRAN” section of the attached Release Notes—XSP 4.50 (page 10), which is incorporated herein in its entirety by reference.

In one exemplary embodiment, the location field code is used throughout the system as a method for distinguishing one holding from another. The location code field may be any size: in one configuration, it is 10 characters, as described in the “CIG007 Location Code Field Expansion” section of the attached Release Notes—XSP 4.50 (pages 11-15), which is incorporated herein in its entirety by reference. Further, users may identify multiple location codes for each custodian and bank identification code (BIC), as described in the “M09691 Multiple Location Codes per BIC” section of the attached Release Notes—XSP 4.50 (page 21), which is incorporated herein in its entirety by reference.

In yet another exemplary embodiment, the system comprises payout functionality, including franked and unfranked payout types. The system also tracks fees. In an alternative embodiment, payout forms include fields for old shares, new shares, fees and fee currencies. A detailed listing of these payout elements is provided in the “M02201 Enhanced Options and Payouts” section of the attached Release Notes—XSP 4.50 (pages 16-18), which is incorporated herein in its entirety by reference.

In yet another exemplary embodiment, the system identifies each corporate action by a unique corporate action ID number. The corporate action ID number can be used to efficiently search for holdings, transactions and notifications tied to specific corporate actions. Users also may use the corporate action ID number when performing queries in the eTRAN module. A detailed description of this element is provided in the “M10642 Add CA ID Option to XSP Query Forms” section of the attached Release Notes—XSP 4.50 (pages 23-25), which is incorporated herein in its entirety by reference.

In one embodiment, the ISO outbound message function may create a separate block for each payout, denoted by an option and payout number. The identifying number for the block may be shown as the option number in conjunction with the payout number; e.g., the identifying number for the block for option no. 1 and payout no. 2 is 012. In an alternative embodiment, the corporate action option number block in the ISO outbound message will contain all payouts for that option number, unless the option contains two payouts of the same type (e.g., two PC payouts). In the latter case, payouts of the same type may be broken out into a separate option block, but still retain the same option number. In another exemplary embodiment, the ISO corporate action import processes, including the ISO intra-day corporate action import and ISO nightly corporate action import are updated to accurately import the options and payouts. Details of this function are provided in the “M11007 Modify Payouts for ISO Outbound Messages” and “M12654 Modify ISO Inbound Corporate Action Import to Read Updated Option Sequences” sections of the attached Release Notes—XSP 4.50 (pages 26, 45), which are incorporated herein in their entirety by reference.

In yet another embodiment, the system creates a report that tracks the price elected for all corporate actions with the corporate action type of “Tender Offer—Dutch Auctions.” The price elected field displays the actual price for which the tender offer was elected. Details of this function are provided in the “M11243 Create Report for TE-DA Corporate Actions” section of the attached Release Notes—XSP 4.50 (page 27), which is incorporated herein in its entirety by reference.

In yet another embodiment, the system will automatically archive notifications that have been sent. Archiving is performed according to predefined conditions. As with notification summaries, the client may determine where the archived files should be stored. This function may be accomplished by designating the location in an appropriate field in the preferences data. In one embodiment, when the archive process is run, it converts the files from a data file (.dat) to Rich Text Format (.rtf) and stores them in the location designated by the client. More information about this system is provided in the “M11244 Automatic Notification Archive System” section of the attached Release Notes—XSP 4.50 (page 28), which is incorporated herein in its entirety by reference.

In another exemplary embodiment, certain detail records may be excluded from the export process at the election of the user, which will reduce the time that the export takes to complete. For example, the user may indicate by unchecking certain preference checkboxes that the D4, D5 and DX detail records be excluded from the export. More information about this option is provided in the “M11276/M11277 Add Preference for Including or Excluding Detail Records in Corporate Action and Cumulative Corporate Action Exports” section of the attached Release Notes—XSP 4.50 (page 29), which is incorporated herein in its entirety by reference.

In yet another exemplary embodiment, the client may select an approval and/or pending approval status that specifies in which application or module a corporate action was reviewed and approved. In addition, a processed status indicator can be used to indicate responses that have already been processed in the instruction processing screen. More details about this process are provided in the “M11360 Add Additional Approval Statuses to XSP and eTRAN” section of the attached Release Notes—XSP 4.50 (pages 30-35), which is incorporated herein in its entirety by reference.

In another embodiment, the system has the ability to distinguish “mini tenders” (tender offers for less than 5% of a company's shares) from regular tender offers and odd lot tenders. Mini tenders are not as strictly regulated by the SEC as regular tender offers, so this permits mini tenders to be separated so clients can fully examine the offer. More information about this element is provided in the “M11441 Add Sub-CA Type to Tender Offers (TE) and Odd Lot Tenders (OT) to Accommodate ‘Mini Tenders’” section of the attached Release Notes—XSP 4.50 (page 36), which is incorporated herein in its entirety by reference.

In yet another exemplary embodiment, clients may configure a “cut-off” time for responses in the eTRAN module. This may be accomplished, for example, by entering the “cut-off” time in a specific field on the eTRAN response screen. After this time on the specified response close date, no further elections will be accepted. More information about this process is provided in the “M11473 Add Response Close Time to eTRAN” section of the attached Release Notes—XSP 4.50 (pages 37-38), which is incorporated herein in its entirety by reference.

In yet another exemplary embodiment, the payout data received from vendors may vary in decimal precision. The system handles decimals in a flexible manner so as to ensure that the entire vendor payout may be viewed and handled. In one alternative configuration, the payout data is limited to a maximum of 15 digits, with up to 9 digits on the left side of the decimal and up to 12 digits on the right side of the decimal. When the maximum length of 15 is reached for a number, the decimal portion is shortened. More information about this process is provided in the “M11795 Enhance Decimal Precision in XSP” section of the attached Release Notes—XSP 4.50 (pages 39-40), which is incorporated herein in its entirety by reference.

In a further exemplary embodiment, the system allows clients to select whether they want to allow users to oversubscribe on all corporate action types, or just on certain specified types, such as (but not limited to) rights issue (RI) and subscription (SU) types. More information on this option is provided in the “M11806 Add Ability to Limit Oversubscription to Specific CA Types” section of the attached Release Notes—XSP 4.50 (page 41), which is incorporated herein in its entirety by reference.

In yet another exemplary embodiment, custodians receive a separate ISO outbound instruction (MT 565) for each BIC code attached to an account. In another exemplary embodiment, the system supports using more than one custodian BIC code for receiving and sending messages. More information about this process is provided in the “M11964 Separate ISO Outbound Files via BIC Code” and “M17220 Add Support for Multiple Sending/Receiving BIC Codes” sections of the attached Release Notes—XSP 4.50 (pages 42-43, 51-52), which are incorporated herein in their entirety by reference.

In one alternative configuration, the “process vendor corporate actions” process may create separate vendor notices when multiple MT564/MT568 messages are imported that do not completely match via the linking logic (e.g., slightly different BIC codes). In another alternative configuration, this process may be expanded to include processing corporate actions on holding trust securities. More information about this process is provided in the “M12425 Add Ability to Designate and Process CA's for Holding Trust Securities” section of the attached Release Notes—XSP 4.50 (page 44), which is incorporated herein in its entirety by reference.

In one exemplary embodiment, custodian account numbers are 15 characters in length. In an alternative embodiment, an extended custodian account number of up to 35 characters may be used. More information about this field is provided in the “M14050 Add Extended Custodian Account Field to Position and Transaction File Layouts” section of the attached Release Notes—XSP 4.50 (page 46), which is incorporated herein in its entirety by reference.

In yet another exemplary embodiment, the system marks a corporate action as “cancelled” if all vendors have submitted a cancellation notice regarding the corporate action. In some instances, however, an internal vendor may be present, and since an internal vendor does not send changes, the corporate action's status may not be changed appropriately. In these circumstances, the corporate action rules alert users when a corporate action should be marked as “cancelled.” More information about this function is provided in the “M14487 Modify Corporate Action Cancellations” section of the attached Release Notes—XSP 4.50 (pages 47-48), which is incorporated herein in its entirety by reference.

In one embodiment, the system notifies users when a new corporate action has been added to an alert-only view, even if other, older corporate actions are still present in the view. More information about this alert function is provided in the “M15506 Modify XSP Alert to Flash for All New CA's in Alert-Only Views” section of the attached Release Notes—XSP 4.50 (page 49), which is incorporated herein in its entirety by reference.

In another embodiment, clients can configure the minimum and maximum length of users IDs and passwords, particularly for the toolbar and eTRAN modules. This allows the system to conform to clients' in-house requirements. More information about this option is provided in the “M15521 Add Ability to Configure Minimum and Maximum Length of User IDs and Passwords in XSP” section of the attached Release Notes—XSP 4.50 (page 50), which is incorporated herein in its entirety by reference.

In yet another exemplary embodiment, the system may use cross-reference logic to send out the option number provided by the custodian to whom the instruction will be sent, regardless of the option number on the composite corporate action. If the system cannot determine the appropriate option number, the option number will be designated as “unsolicited”. Any instructions created with an “unsolicited” designation will be written to a separate exceptions file that will be located in the same directory configured for the generated MT 565 outbound instructions. More information is provided in the “M17500 Modifying ISO Outbound Message Processing” section of the attached Release Notes—XSP 4.50 (page 53), which is incorporated herein in its entirety by reference.

In another exemplary embodiment, the system reconciles accounts and number of shares indicated on an inbound MT 564 message with the intended custodian's accounts and number of shares held in the system. More information about this reconciliation process is provided in the “XCS034 ISO MT564 Inbound Account Reconciliation” section of the attached Release Notes—XSP 4.50 (pages 55-57), which is incorporated herein in its entirety by reference.

In yet another exemplary embodiment, clients are able to set up queues and views for certain areas of the system, including the ability to customize the list layout, and flexibility in setting up users for alerts. Detailed information about this function is provided in the “XCS054 Work Queues—Phase 3” section of the attached Release Notes—XSP 4.50 (pages 58-60), which is incorporated herein in its entirety by reference.

In another embodiment, the system allows a user to define or import standing election instructions (i.e., standing instructions) for a corporate action type if the account holder has not provided a response before a specified date. The standing instructions will be applied automatically on the specified date if no other response has been provided. More details about this process are provided in the “XCS058 Standing Election Instructions” section of the attached Release Notes—XSP 4.50 (pages 61-66), which is incorporated herein in its entirety by reference.

In one embodiment, the system uses a standard calculation method that does not drop fractional shares when calculating entitlement shares. However, many countries require that any fractional shares be dropped when calculating entitlements, so that figures will be calculated against a whole number of shares (i.e., the allotment method). Accordingly, in an alternative embodiment, the system allows clients the option to select either the standard or allotment method when calculating entitlements. More detailed information about this option is provided in the “XCS059 Allotment Calculation Method” section of the attached Release Notes—XSP 4.50 (pages 67-69), which is incorporated herein in its entirety by reference.

In yet another exemplary embodiment, the system allows clients to specify whether or not users will be allowed to grant “approval” to corporate actions that the users themselves have modified. When this option is selected, the user ID of the user attempting to grant approval is compared with the user ID of the user who modified the corporate action, and if they are the same, the system will not grant approval and will display a warning message. More information about this process is provided in the “XCS060 Allow Client to Restrict Granting of Approval to CA's” section of the attached Release Notes—XSP 4.50 (pages 70-71), which is incorporated herein in its entirety by reference.

In another exemplary embodiment, the eTRAN module has enhanced security protection. The password has a minimum of 8 characters, and login rules are established so that a user can only make 5 attempts to login before being locked out. In addition, administrators are provided a record of user login attempts. More information about eTRAN security elements is provided in the “XCS102 eTRAN/Response Enhancements” section of the attached Release Notes—XSP 4.50 (page 72), which is incorporated herein in its entirety by reference.

Thus, it should be understood that the embodiments and examples have been chosen and described in order to best illustrate the principals of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art. Accordingly, it is intended that the scope of the invention be defined by the claims appended hereto.

We claim:

1. A system for handling corporate action data, comprising:
a set of data management tools to import, manage and process said data, said data management tools comprising
a scheduler module to manage the importation and initial processing of data from one or more data sources, and to place the imported and processed data into a database;
a toolbar module to allow the data in the database to be reviewed or modified by a user;
a management report module to allow the user to create one or more data reports based on user requirements;
an archive viewer to enable the user to save and view data records; and
means to ensure that corporate events are properly matched to create a corporate record; and
a set of notification and response tools to provide notifications of corporate actions and handle responses, said notification and response tools comprising
a notification module to create and deliver corporate action notifications; and
a remote response module to enable a user to view and submit response to corporate actions from remote locations.

2. The system of claim 1, further comprising
an entitlement module to calculate corporate action entitlements.

3. The system of claim 2, wherein the entitlement module calculates an option payment after the user has made an election as to an option.

4. The system of claim 2, wherein the entitlement module calculates a dividend or interest payment.

5. The system of claim 1, wherein the remote respond module is operable through the Internet.

6. The system of claim 1, said data management tools further comprising a series of electronic work queues, views and alerts to allow for workflow management and exception processing.

7. The system of claim 1, wherein said matching means comprise a vertical matrix cross reference table that cross-references security identifiers.

8. The system of claim 1, wherein said data sources include commercial electronic corporate actions data source suppliers.
